(19) United States
(12) Patent Application Publication
(10) Pub. No.: US 2017/0129709 A1
(43) Pub. Date: May 11, 2017

(54) CONDUCTOR TRANSPORTATION DEVICE, IN PARTICULAR FOR CABLES TO BE PROCESSED IN CABLE-PROCESSING MACHINES

(71) Applicant: Schleuniger Holding AG, Thun (CH)

(72) Inventors: Michael MAZUR, Echzell (DE); Benjamin SCHÄFER, Bischoffen (DE)

(73) Assignee: Schleuniger Holding AG, Thun (CH)

(21) Appl. No.: 15/335,983

(22) Filed: Oct. 27, 2016

(30) Foreign Application Priority Data
Nov. 8, 2015 (EP) 15193568.1

(51) Int. Cl. B65G 21/12; B65H 51/18; B65G 15/14

(52) U.S. Cl. CPC B65G 21/12; B65G 15/14; B65H 51/18; B65H 2701/341

(57) ABSTRACT

A conductor transportation device for cables has a pivoting conductor conveyor. A first drive moves the conductor conveyor about a pivotal axis. The conductor conveyor has a conveyance (30a) such as, a conveyor belt running around a drive roller and a roller, together with a pressure application. A second drive is present for the. The axes of rotation of rollers (30b, c, e, f) for the conveyance and pressure application are parallel to one another and also to the pivotal axis of the conductor conveyor. A drive axis of the drive is coincident with one of the axes of rotation of the rollers. One of the axes of rotation of the rollers is coincident with the pivotal axis for the conductor conveyor. The actuation paths of the pivotal axis and the conveyor roller or the driven roller are spaced apart.

### CROSS REFERENCE TO RELATED APPLICATIONS

This application claims the priority of the European Application No. EP15193568.1, filed on Aug. 11, 2015, which is here incorporated in its entirety by reference expressly and explicitly to the whole and in all arbitrary parts, for all intents and purposes, in the same way as if identically completely incorporated in the present application.

### BACKGROUND

A conductor transportation device, in particular for cables to be processed in cable-processing machines, together with a cable-processing machine, with at least two processing stations for at least one end of the cable, are disclosed herein.

A corresponding device is disclosed in WO2009/0141794A1, wherein a first drive is fixedly connected with a base frame, in order to effect a precisely defined rotational movement of the conductor conveyor about a pivotal axis. A second drive is provided for purposes of actuating the conductor conveyor and is also fixedly mounted on the base frame. Here the drive axis of the second drive coincides with the pivotal axis of the conductor conveyor. The transmission of the pivotal movement of the conductor conveyor is effected via a toothed belt, which is clamped symmetrically to the centre of rotation of the pivotal axis between a first intermediate shaft, wherein a second intermediate shaft is also attached to the machine frame. A pitch axis of the conductor conveyor is oriented perpendicular to the drive axes, that is to say, to the axes of the intermediate shafts. This device thus has two spatially separated drive axes, one axis for purposes of driving the one or more means of conveyance of the conductor conveyor, and a separate drive axis for the pivotal movement of the whole conductor conveyor.

In accordance with U.S. Pat. No. 5,784,770A a conductor production machine has a mechanism for supplying a wire for purposes of positioning the end of the wire in relation to an applicator press. The mechanism comprises a wire feeder unit on a pivotable platform. Two concentric drive shafts are provided, wherein the outer shaft is hollow and the inner shaft runs within the outer shaft. The inner shaft is coupled in terms of drive with the feeder unit of the mechanism, while the outer shaft is attached rigidly onto the platform, in order to pivot the latter. A single actuating motor drives selectively both the inner and outer shafts, wherein by means of two couplings one of the shafts can be engaged or disengaged as required, wherein in each case one shaft is locked in its respective position, while the other shaft can be rotated by the motor. With this simultaneous conveying and pivotal movement is not possible, which e.g. also makes the setting up of the exact positions of the wire relative to the stations of the machine very difficult. Moreover, the platform cannot be pivoted in the vertical direction, so that the lowering movement of the conductor end into the crimping tool of the station must be accommodated via the flexibility of the conductor.

### SUMMARY

It was therefore the object of the present invention to develop further a conductor transportation device, such that it allows a greater dynamic range of all movements, at the same time with a simpler form of construction and economical production and maintenance. A further object was that of specifying a cable-processing machine, in which these advantages are implemented for the integrated conductor transportation device.

For purposes of achieving these objects, features, advantageous and further developments are presented in the description, the figures, and in the patent claims.

Here the starting point is a conductor transportation device with a conductor conveyor mounted such that it can pivot for a conductor that is to be drawn in and transported, with a first drive preferably fixedly connected with a base frame for purposes of achieving a precisely defined pivotal movement of the conductor conveyor about a pivotal axis, with at least one driven means of conveyance, for example a driven conveyor roller, or a conveyor belt running around at least one drive roller and a further roller, and an opposing means of pressure application, for example a pressure roller or a pressure belt running around at least two rollers, which means of conveyance and means of pressure application are arranged on a pivotable conductor conveyor, with a second drive preferably fixedly connected with the base frame for at least the driven conveyor roller or the drive roller, wherein the axes of rotation of all rollers run parallel to one another and also parallel to the pivotal axis of the conductor conveyor.

For purposes of achieving the object presented above in accordance with the invention this device is characterised in that one of the axes of rotation of the rollers is coincident with the pivotal axis for the conductor conveyor, wherein, however, the actuation paths of the pivotal axis and the conveyor roller or the driven roller are nevertheless separated. Here one drive axis of the drive for the conveyor rollers or the driven rollers of the conductor conveyor also preferably remains coincident with one of the axes of rotation of the rollers.

As a result of the integration of the two axes of rotation, that for the pivotal movement of the conductor conveyor, and that for one of the axes of the elements of the conductor conveyor conveying the conductor, the efficiency during the pivotal movement and the conveyor movement can be increased. By saving on one transmission unit both a cost saving and also a weight reduction is possible. By this means the moment of inertia of the pivotable module of the conductor conveyor in the pivotal direction is also significantly reduced by the reduction of mass and the proximity of the centre of gravity to the point of rotation. As a result, the drive is more dynamic and the power requirement is less compared with conductor conveyors in accordance with the prior art. Finally, the backlash between forward and rearward conveyor movements is reduced by the elimination of the drive belt.

Here the drive axis is preferably coincident with the axis of rotation of the conveyor roller or the driven roller, as a result of which the advantages previously specified can be increased further.

Here an advantageous form of embodiment provides for the drive axis for the conductor conveyor also to be coincident with the pivotal axis for the conductor conveyor.

In accordance with an advantageous form of embodiment of the invention the actuation path of the pivotal axis has a drive means with a drive axis and a pivotal belt, which can be moved by means of the drive axis, wherein the drive axis and the pivotal axis run parallel to one another.

In order to increase the flexibility of movement of the conductor conveyor, one form of embodiment of the invention is characterised in that the actuation path of the conveyor rollers or the driven roller has a drive means with a drive axis, wherein a flexible shaft coupling connects the drive axis and the conveyor rollers or the driven rollers.

A further inventive form of embodiment is characterised in that at least one pressure roller, or one of the rollers for a pressure belt, can be driven by means of the drive means of the conveyor rollers or the driven roller, wherein either an actuation path branches off from the drive axis, or an actuation path leads from another roller on the conductor conveyor onward to a pressure roller or one of the rollers for the pressure belt.

The means of pressure application is preferably adjustable relative to the means of conveyance in a direction perpendicular to the axes of rotation, so that the device can be adapted to various cable dimensions.

In accordance with a further form of embodiment of the invention a pitch axis runs perpendicular to the pivotal axis, on which the conductor conveyor is fitted such that it can be pivoted. By this means the piece of conveyed cable protruding from the conductor conveyor can be lowered or raised, for example in order to be able to position it better for further processing steps.

Here a drive is preferably provided for the pivotal movement of the conductor conveyor about the pitch axis in at least one pivotal direction, and a spring element preferably exerts force on the conductor conveyor against the action of the drive. This simplifies the positioning of the conveyed cable and the restoration into the conductor conveyor position for purposes of pivotal movement, or conductor transportation.

The object set in the introduction is also solved by means of a cable-processing machine with at least two processing stations for at least one end of a cable, and a conductor transportation device for purposes of conveying the cable in its longitudinal direction and between the processing stations, which device is embodied as presented in the above paragraphs.

Here one of the processing stations is preferably a crimping station and the conductor transportation device is preferably mounted such that it can be moved about a pitch axis, actuated via a drive. Here the pivotal movement of the end of the conductor conveyor remote from the pitch axis takes place by means of the drive in a direction towards a lower crimping die arranged in the crimping station, and movement in the counter-direction is preferably effected by the application of force with a spring element.

In a particularly advantageous manner the drive is formed by the press slide present in the crimping station and a ram attached to the press slide, which ram presses the conductor conveyor downwards at the start of the crimping process.

Further advantages, features, and details of the invention ensue from the following description, in which examples of embodiment of the invention are described with reference to the figures. Here each of the features referred to in the claims and in the description can be essential to the invention either individually or in any combination.

### BRIEF DESCRIPTION OF THE DRAWING

The list of reference symbols is an integral part of the disclosure, as is also the technical content of the patent claims and the figures. The figures are described coherently and comprehensively. The same reference symbols denote the same components; reference symbols with different indices specify components with the same or similar functions. Here:

FIG. 1 shows an exemplary view of the inventive conductor transportation device from above,

FIG. 2 shows a perspective view of the conductor transportation device of FIG. 1 with the conductor conveyor in a first pivotal position,

FIG. 3 shows a view corresponding to FIG. 2 with the conductor conveyor in a second pivotal position,

FIG. 4 shows a side view of the conductor transportation device of FIGS. 1 to 3, with the conductor conveyor in a lowered position,

FIG. 5 shows a view of the conductor transportation device in FIG. 1 from the front, with the conductor conveyor in the horizontally aligned position for purposes of conveying the cable, and

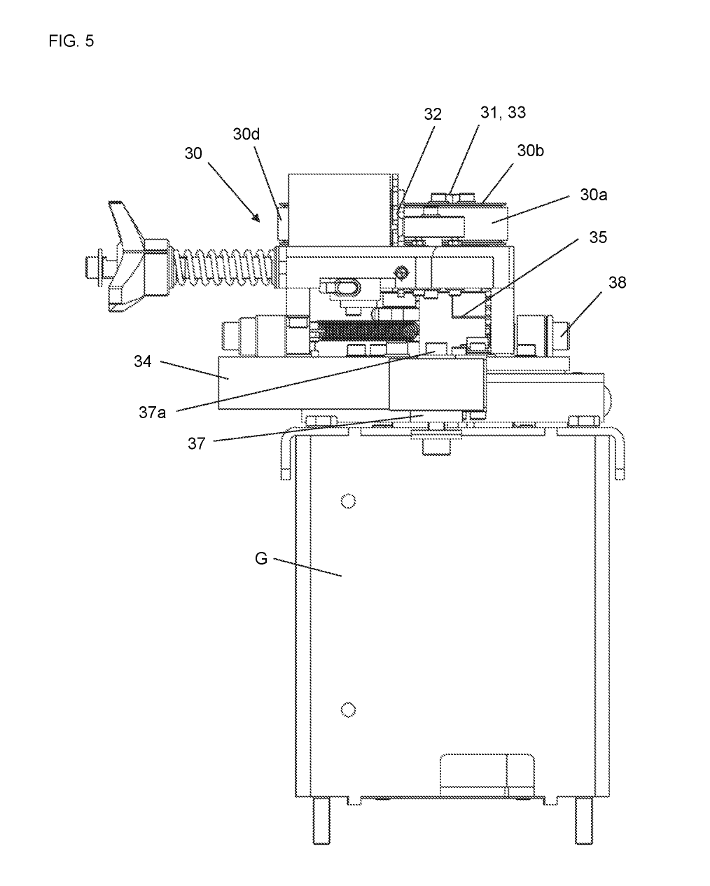

FIG. 6 shows a view corresponding to FIG. 5, but with the conductor conveyor in a lowered position, corresponding to that in FIG. 4.

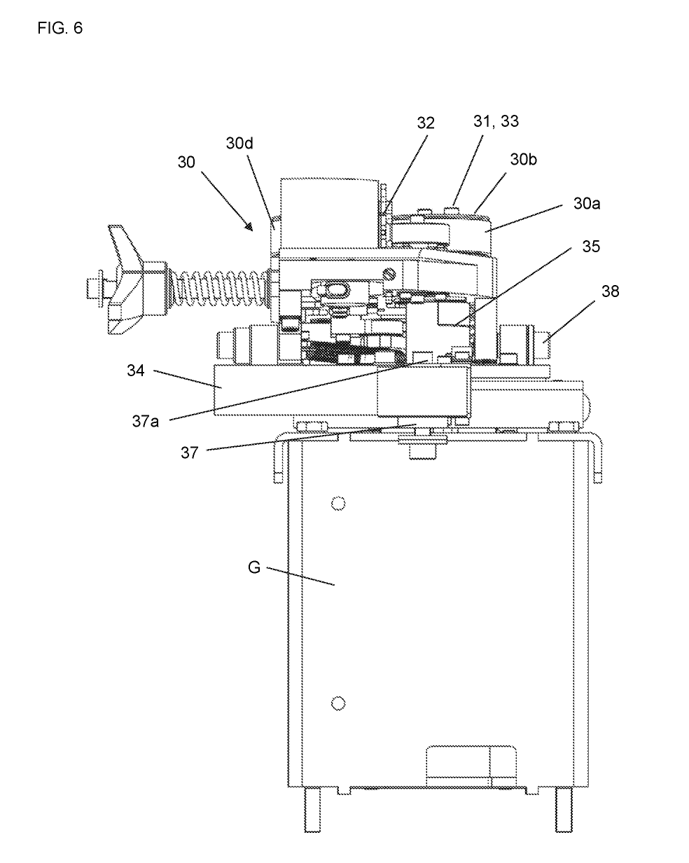

### DETAILED DESCRIPTION

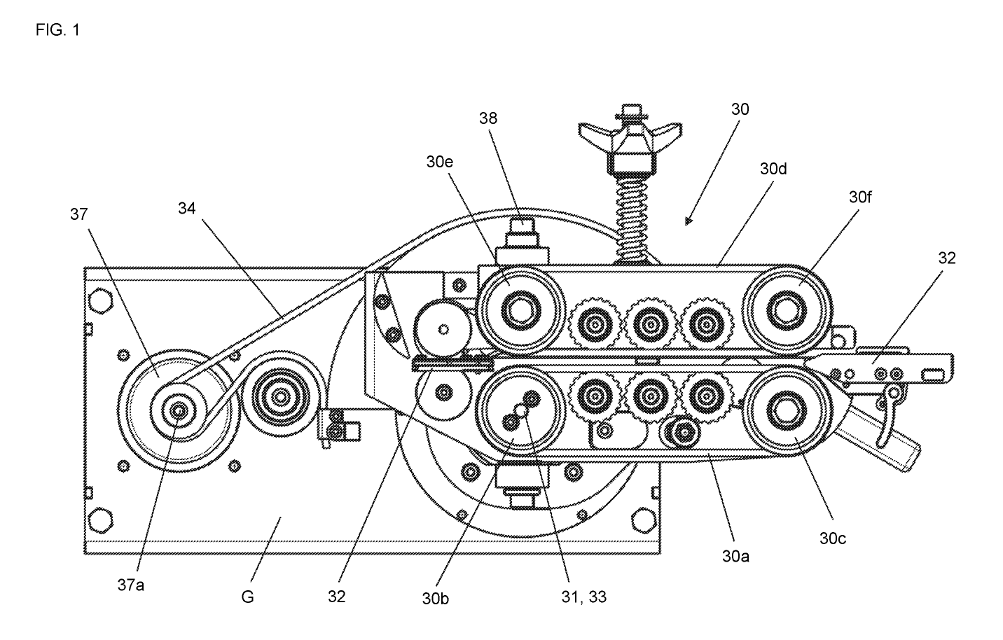

As can be seen in FIG. 1 the inventive conductor transportation device comprises a base frame G, on which is mounted a conductor conveyor 30 that can pivot about at least a first axis 31. The axis 31 is usually oriented essentially vertically, so that the movement of the conductor conveyor—and also the cable that is transported by the latter—takes place in an essentially horizontal plane. By means of the pivotal movement of the conductor conveyor 30 the cable end of a transported cable, or any similar type of conductor, projecting beyond the conductor conveyor 30, can be transported to various processing stations that are preferably arranged along a circular arc. One of these processing stations in a cable-processing machine, into which a cable is to be drawn by means of the conductor conveyor 30, is typically a crimping station.

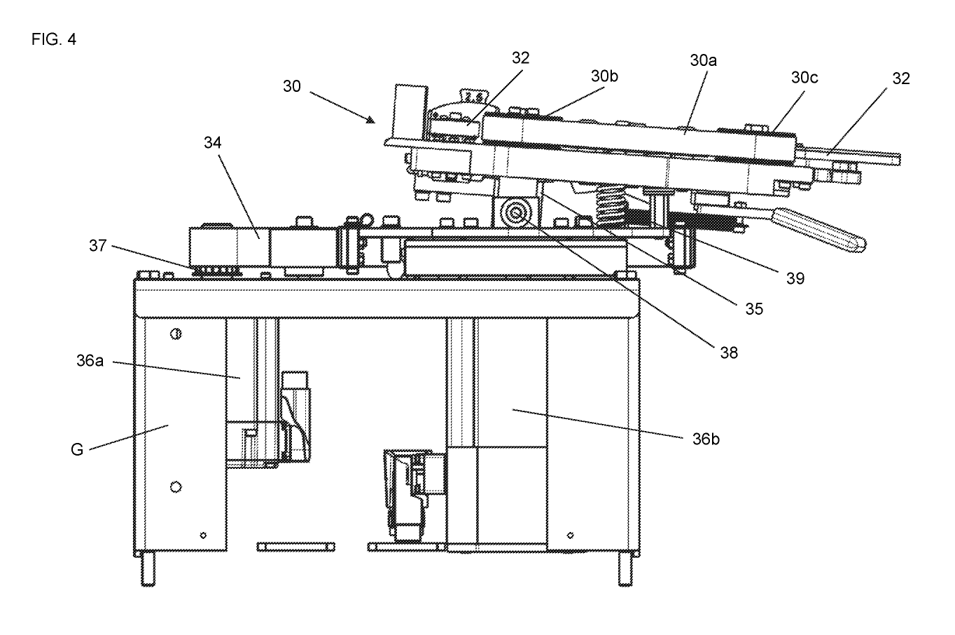

A first drive 36a is fixedly connected with the base frame G of the device, with which a precisely defined pivotal movement of the conductor conveyor 30 about a pivotal axis 31 can be effected. The energy for this pivotal movement is transmitted by means of a pivotal belt 34. This pivotal belt 34, preferably embodied as a toothed belt, runs over a drive shaft 37, which defines a drive axis 37a of the drive 36a for the conductor conveyor 30, which is preferably parallel to the pivotal axis 31 of the conductor conveyor 30 (see FIG. 4). If necessary, an arrangement can also be provided in which a drive axis for the conductor conveyor 30 coincides with its pivotal axis 31.

Conveyance of the cable takes place by means of at least one driven means of conveyance 30a, seated on the conductor conveyor 30, in particular a driven conveyor roller, or preferably a conveyor belt running around at least one drive roller 30b and one other roller 30c. The cable is advantageously clamped between the said means of conveyance 30a and an opposing means of pressure application 30d, also seated on the conductor conveyor 30, which means of pressure application 30d can, for example, be a pressure roller, or a pressure belt running around at least two rollers 30e, 30f. The means of conveyance 30a, or more particularly its drive roller 30b, are connected in terms of drive with a drive 36b, preferably fixedly connected with the base frame G. This drive can advantageously be performed via a flexible shaft coupling 35, in order to enable pitch movements of the conductor conveyor 30 out of the essentially horizontal plane of the pivotal movement about the axis 31. The means of pressure application 30d is preferably mounted on the conductor conveyor 30 such that it can be adjusted relative to the means of conveyance 30a, and can also, if necessary, be subjected to a spring force onto the means of conveyance 30a by means of an elastic arrangement, such that in between it can accommodate cables with various diameters. The means of pressure application 30d could also itself be driven. The axes of rotation of all rollers 30b, c, e, f are preferably parallel to one another and preferably also run parallel to the pivotal axis 31 of the conductor conveyor 30. At the same time the said axes of rotation are preferably also parallel to the axis 37a of the drive for pivotal movement of the conductor conveyor 30 about the axis 31.

The shaft coupling 35 is connected to the underside of the driven roller 30b, so that the drive axis 33 of the means of conveyance 30a not only lies parallel to the axis of the said roller 30b, but in fact is preferably coincident with it—and also preferably coincides with the pivotal axis 31 of the conductor conveyor 30. With this arrangement no transmission unit is any longer required between the drive 36b for the means of conveyance 30a, and the conductor conveyor 30.

At the same time an arrangement of one of the rollers 30b, c, e, f, preferably once again the driven roller 30b, coincident with the pivotal axis 31 for the conductor conveyor 30, is particularly advantageous. The actuation paths of the pivotal axis 31 and the conveyor roller or the driven roller 30b are, however, spaced apart, so that simple independent control of the drives 36a, b is possible, and thereby a simple independent movement of the means of conveyance 30a for purposes of transporting the cable in its longitudinal direction, and of the conductor conveyor 30 for purposes of its pivotal movement.

In the form of embodiment of an inventive conductor transportation device represented in the figures the two structural axes 31 of the pivotal movement of the conductor conveyor 30, that is to say, the pivotal axis 31, and the drive axis 33 of the conductor conveyor, that is to say, the driven axis 33 of the driven roller 30b, are merged into one structural axis 31, 33. The drive 36b for the belt conveyor roller 30b is mounted fixed to the base frame G, and the drive 36a for the pivotal function of the conductor conveyor 30 is similarly mounted fixed to the frame, and in the example of embodiment represented it is spaced apart on the frame G from the drive 36b. If necessary the drives 36a, b can be combined in one module, but with separate drive shafts. Furthermore, the pivotal axis 31 is also identical with the central axis 33 of the driven belt conveyor roller 30b.

It should be noted that as a result of the inventive unification of the pivotal axis and the belt conveyor axis, the conductor conveyor 30 pivots about an axis of rotation 31 outside the conductor axis and the conductor guide 32. This leads to an unfavourable alteration of the pivotal behaviour, as result of which the pivotal movement is conducive to the formation of a loop; however, by an informed choice of the diameter of the means of belt conveyance 30a, together with the angle at which the conductor guide 32 stands relative to the conductor axis, this can be limited to an acceptable amount. The pivotal axis of the conductor conveyor 30 is, as stated above, coincident with the central axis of the driven roller 30b of the means of conveyance 30a.

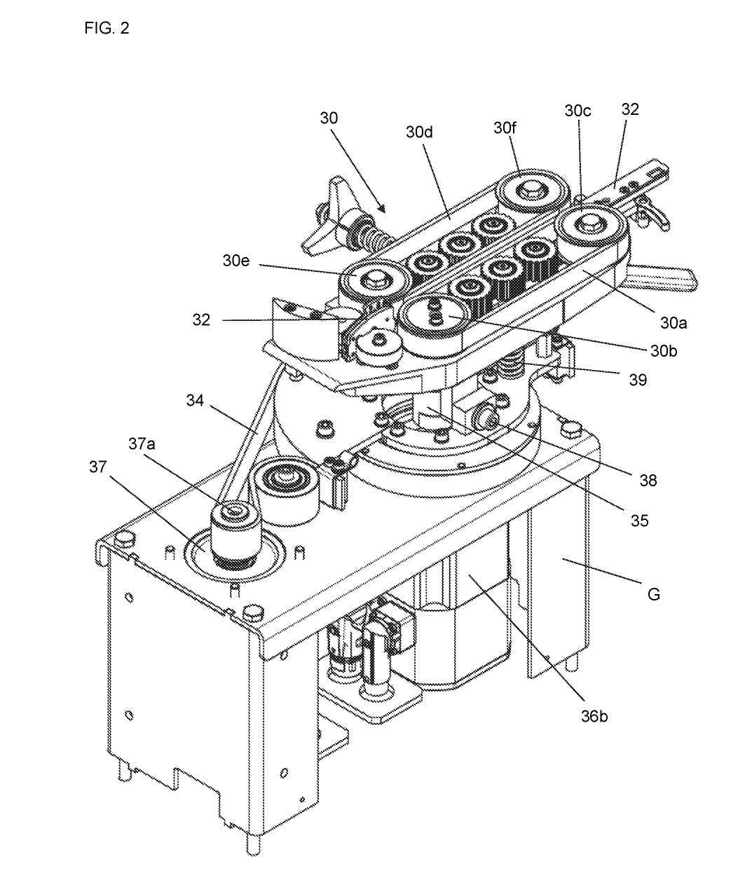

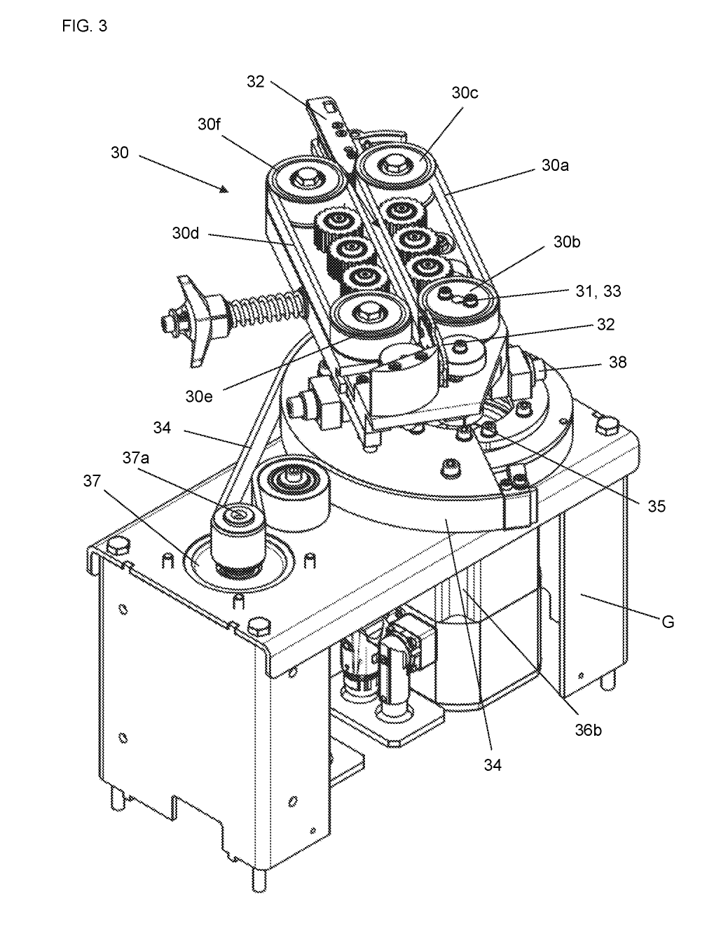

During the pivotal movement of the conductor conveyor 30 the entry point of the conductor guide 32 describes a circular arc about the pivotal axis 31. As dictated by this circular arc, during the pivotal movement the conductor guide entry point travels up to approx. 30° firstly along a short path length in the direction of the conductor guide 32, coming from the left in FIGS. 1 to 3. It would therefore form a small conductor loop ahead of the conductor entry point into the conductor guide 32. At the same time the conductor guide is displaced approximately parallel laterally by 30° relative to the 0° guide position along a corresponding path length. The distance to the upstream conductor guide units, e.g. to the straightening unit, should therefore be relatively large, in order to ensure an approximate parallelism. In the range of between 30° and 60° pivotal movement, the conductor guide entry point travels back in the direction of the pivotal axis 31. As a result of this effect the conductor loop previously present would therefore be smoothed out, and in addition more conductor would be drawn out from the supply on the left-hand side. If there is now a pivotal movement back to 0°, this conductor loop remains ahead of the conductor guide 32.

During the conveyancing process, such conductor loops must firstly be smoothed out with a moderate acceleration. Jerky acceleration could possibly damage or overstretch the conductor. Cutting the conductor to length, and conveyancing of the conductor, takes place in the 0° pivotal position. The aim of the design is therefore to achieve as small a loop formation as possible for the 0° pivotal position. It should be noted in particular that after severance, and during the removal of insulation, the conductor is conveyed backwards by approx. 25 mm, so that a conductor loop is already created in this process between the conductor guide entry point and the straightening unit. The conductor loop length additionally created as a result of the pivotal movement process in the present invention is theoretically shorter than the conductor loop generated during the process of severance and insulation removal, so that the pivotal process does not have a negative influence on loop formation.

As described above the conductor conveyor 30 can not only be pivoted about the axis 31 in the essentially horizontal plane. A pivotal movement about the pitch axis 38 out of this horizontal pivotal plane is also possible; this is preferably performed by a further drive. Restoration into the horizontal or any other plane perpendicular to the axis 31 is preferably effected by means of a spring element 39.

The inventive cable transportation device is typically deployed in conjunction with a cable-processing machine with at least two processing stations for at least one end of a cable. In this case the cable is conveyed in its longitudinal direction and is transported between the processing stations, normally distributed along a circular segment. One of these processing stations is a crimping station in which, for purposes of attaching a crimping component, the cable end is conveyed not only axially but also into the crimping station, in particular it must be lowered into a crimping bottom die arranged in the latter. For this configuration it is advantageously possible for the drive for lowering the end of the conductor conveyor 30 distant from the pitch axis 38—onto the crimping bottom die arranged in the crimping station—to be formed by means of the press slide present in the crimping station and a ram attached to the press slide. The said ram acts on the conductor conveyor 30 during the downward movement of the press slide at the start of the crimping process, and presses the end of the conductor conveyor 30 that is remote from the pitch axis 38 downwards against the action of the spring element 39. When the crimping tool opens, i.e. when the press slide is raised, the ram also lifts and the spring element 39 can pivot the conductor conveyor 30 back into the plane located essentially perpendicular to the axis 31.

### LIST OF REFERENCE SYMBOLS

30 Conductor conveyor

30a Means of conveyance

30b Driven roller for the means of conveyance

30c Roller for the means of conveyance

30d Means of pressure application

30e, f Rollers for the means of pressure application

31 Pivotal axis

32 Conductor guide

33 Axis of the driven roller

34 Pivotal belt

35 Flexible shaft coupling

36a Drive motor for conductor conveyor

36b Drive motor for belt conveyor roller

37 Drive shaft for conductor conveyor

37a Axis of the drive for the conductor conveyor

38 Pitch axis

39 Spring element

G Base frame of the conductor transportation device

1. A conductor transport device for cables to be processed in cable-processing machines, comprising:
a conductor conveyor (30), mounted such that it can pivot, for a conductor that is to be drawn in and transported,
a first drive (36a) fixedly connected with a base frame (G) for purposes of achieving a precisely defined pivotal movement of the conductor conveyor (30) about a pivotal axis (31),
at least one driven mechanism of conveyance (30a) having a driven conveyor roller or a conveyor belt running around at least one drive roller (30b) and a further roller (30c), and
an opposing element of pressure application (30d) having a pressure roller or a pressure belt running around at least two rollers (30e, 30f),
wherein the mechanism of conveyance (30a) and the element of pressure application (30d) are arranged on a pivotable conductor conveyor (30), with a second drive (36b) preferably fixedly connected with the base frame (G) for at least the driven conveyor roller or the drive roller (30b),
wherein the axes of rotation of all rollers (30b, c, e, f) run parallel to one another and also parallel to the pivotal axis (31) of the conductor conveyor (30),
wherein one of the axes of rotation of the rollers (30b, c, e, f) is coincident with the pivotal axis (31) for the conductor conveyor (30),
wherein one drive axis of the drive (36b) for the conveyor rollers or the driven rollers (30b) of the conductor conveyor (30) is coincident with one of the axes of rotation of the rollers (30b, c, e, f), and
wherein the actuation path of the pivotal axis (31) and the conveyor roller or the driven roller (30b) are separated.

2. The device in accordance with claim 1, wherein the drive axis of the conveyor roller or the driven roller (30b) is coincident with the axis of rotation (33) of the conveyor roller or the driven roller (30b).

3. The device in accordance with claim 1, wherein the drive axis (37a) for the conductor conveyor (30) is coincident with the pivotal axis (31) for the conductor conveyor (30).

4. The device in accordance with claim 3, wherein the actuation path of the pivotal axis (31) has a drive means with a drive axis (37a) and a pivot belt (34), which can be moved by means of the drive axis (37a), wherein the drive axis (37a) and the pivotal axis (31) run parallel to one another.

5. The device in accordance with claim 4, wherein the actuation path of the conveyor rollers or the driven roller (30b) has a drive (36b) with a drive axis, wherein a flexible shaft coupling (35) connects the drive axis with the conveyor rollers or the driven rollers (30b).

6. The device in accordance with claim 1, wherein at least one pressure roller, or one of the rollers (30e, 30f) for a pressure belt (30d), can be driven by means of the drive (36b) of the conveyor rollers or the driven roller (30b), wherein either an actuation path branches off from the drive axis, or an actuation path of another roller on the conductor conveyor (30) leads onward to a pressure roller or one of the rollers (30e, 30f) for the pressure belt (30d).

7. The device in accordance with claim 1, wherein the element of pressure application (30d) can be adjusted relative to the means of conveyance (30a) in a perpendicular direction to the axes of rotation.

8. The device in accordance with claim 1, wherein a pitch axis (38) runs perpendicular to the pivotal axis (31), on which the conductor conveyor (30) is fitted such that it can be pivoted.

9. The device in accordance with claim 8, wherein a drive is provided for the pivotal movement of the conductor conveyor (30) about the pitch axis (38) in at least one pivotal direction, and preferably a spring element (39) biases the conductor conveyor (30) against the action of the drive.

10. A cable-processing machine, comprising:
at least two processing stations for at least one end of a cable, and
a conductor transportation device for purposes of conveying the cable in its longitudinal direction and between the processing stations, wherein the conductor transportation device includes:
a conductor conveyor (30), mounted such that it can pivot, for a conductor that is to be drawn in and transported,
a first drive (36a) fixedly connected with a base frame (G) for purposes of achieving a precisely defined pivotal movement of the conductor conveyor (30) about a pivotal axis (31),
at least one driven mechanism of conveyance (30a) having a driven conveyor roller or a conveyor belt running around at least one drive roller (30b) and a further roller (30c), and
an opposing element of pressure application (30d) having a pressure roller or a pressure belt running around at least two rollers (30e, 30f),
wherein the mechanism of conveyance (30a) and the element of pressure application (30d) are arranged on a pivotable conductor conveyor (30), with a second drive (36b) preferably fixedly connected with the base frame (G) for at least the driven conveyor roller or the drive roller (30b),
wherein the axes of rotation of all rollers (30b, c, e, f) run parallel to one another and also parallel to the pivotal axis (31) of the conductor conveyor (30),
wherein one of the axes of rotation of the rollers (30b, c, e, f) is coincident with the pivotal axis (31) for the conductor conveyor (30),
wherein one drive axis of the drive (36b) for the conveyor rollers or the driven rollers (30b) of the conductor conveyor (30) is coincident with one of the axes of rotation of the rollers (30b, c, e, f), and
wherein the actuation path of the pivotal axis (31) and the conveyor roller or the driven roller (30b) are separated.

11. The machine in accordance with claim 10, wherein:
one of the processing stations is a crimping station, and a pitch axis (38) runs perpendicular to the pivotal axis (31), on which the conductor conveyor (30) is fitted such that it can be pivoted, and
the pivotal movement of the end of the conductor conveyor (30) remote from the pitch axis (38) in the direction of a lower crimping die arranged in the crimping station takes place by means of the drive, and the movement in the counter-direction is preferably effected by the application of a force by means of a spring element (39).

12. The machine in accordance with claim 11, wherein the drive is formed by the press slide present in the crimping station and a ram attached to the press slide, which ram presses the conductor conveyor (30) downwards at the start of the crimping process.
